(19) United States
(12) Patent Application Publication
(10) Pub. No.: US 2007/0097219 A1
(43) Pub. Date: May 3, 2007

(54) IMAGE STABILIZER, AND IMAGE SHAKE CORRECTION METHOD FOR IMAGING DEVICE

(75) Inventors: Hiroshi NOMURA, Tokyo (JP); Shinichi KAKIUCHI, Tokyo (JP)

Correspondence Address: GREENBLUM & BERNSTEIN, P.L.C., 1950 ROLAND CLARKE PLACE, RESTON, VA, 20191, US

(73) Assignee: PENTAX CORPORATION, Tokyo (JP)

(21) Appl. No.: 11/550,063

(22) Filed: Oct. 17, 2006

(30) Foreign Application Priority Data
Oct. 18, 2005 (JP) P2005-303465

(51) Int. Cl. H04N 5/228

(52) U.S. Cl. 348/208.7

(57) ABSTRACT

An image stabilizer includes an imaging device including an object coverage area changing device for changing an object coverage area, and an image sensor; an image shake correction device which moves a shake correction optical element of the imaging optical system in a plane orthogonal to an optical axis in accordance with a direction and magnitude of vibration applied to the image sensor; a memory, in which area data is prestored, the area data designating changes in relative sizes between an image circle of the imaging optical system and an effective picture area of an imaging surface of the image sensor; and a moving range controller which changes a moving range of the shake correction optical element that corresponds to a change of the object coverage area in accordance with an operating state of the object coverage area changing device based on the area data.

### BACKGROUND OF THE INVENTION

1. Field of the Invention

The present invention relates to an image stabilizer, and further relates to a method of correcting image shake in an imaging device by moving a part of an imaging optical system in a plane orthogonal to an optical axis of the imaging optical system.

2. Description of the Prior Art

Optical image stabilizers (shake reduction systems) prevent (reduce) image shake of an object image formed on an imaging surface by moving a part of an optical system relative to an optical axis thereof so that the part of the optical system shifts from the optical axis in accordance with the direction and the magnitude of vibration (shake) applied to the optical device in which the image stabilizer is incorporated. Since the operating range of the movable part of the optical system must be made to remain within a range in which image quality does not deteriorate (in which a sufficient amount of marginal rays is collected to prevent vignetting from occurring), the effective aperture of the lens must be increased to achieve a wide operating range, which undesirably increases the size of the optical device. Additionally, since a long focal-length optical system has a large magnification, the amount of shake correction per unit of shake angle becomes great, which makes it difficult to miniaturize the image stabilizer.

### SUMMARY OF THE INVENTION

The present invention provides a compact image stabilizer which is configured to be capable of reliably correcting image shake even if the magnification is large. The present invention further provides a method of correcting image shake by which image shake can be corrected reliably using a compact image stabilizer even if the magnification of the optical system thereof is large.

According to an aspect of the present invention, an image stabilizer is provided, including an imaging device including an object coverage area changing device for changing an object coverage area for an object which is to be photographed through an imaging optical system; an image shake correction device which moves a shake correction optical element of the imaging optical system in a plane orthogonal to an optical axis in accordance with a direction and magnitude of vibration applied to the imaging device; a memory, in which area data is prestored, the area data designating changes in relative sizes between an image circle of the imaging optical system and an effective picture area of an imaging surface of the imaging device when the object coverage area changing device changes the object coverage area; and a moving range controller which changes a moving range of the shake correction optical element that corresponds to a change of the object coverage area in accordance with an operating state of the object coverage area changing device based on the area data prestored in the memory.

It is desirable for the moving range controller to change the moving range of the shake correction optical element within a range so that no part of the effective picture area deviates outside from the image circle.

It is desirable for the object coverage area changing device to include an optical zoom device which changes distances in the optical axis direction between optical elements of the imaging optical system that are positioned on the optical axis to vary an optical focal length.

It is desirable for the moving range controller to operate so as to increase the moving range of the shake correction optical element as the optical focal length of the optical zoom device increases.

It is desirable for the imaging optical system to include an image sensor which produces an electronic image of the object, and for the object coverage area changing device to trim a part of the electronic image to change the effective picture area.

It is desirable for the moving range controller to operates so as to increase the moving range of the shake correction optical element as an area of a remaining part of the electronic image, that remains after the trimming, decreases.

It is desirable for the imaging optical system to include an image sensor which produces an electronic image of the object. The object coverage area changing device includes an optical zoom device which changes distances in the optical axis direction between optical elements of the imaging optical system that are positioned on the optical axis to vary an optical focal length; and an electronic zoom device which trims a part of an image formed on the image sensor to change the effective picture area.

It is desirable for the shake correction optical element to be an image sensor.

It is desirable for the imaging optical system to be a zoom lens system and an image sensor.

In an embodiment, an image stabilizer is provided, including an imaging optical system including an image sensor and an optical zoom device for changing a focal length; an image shake correction device which moves a shake correction optical element of the imaging optical system in a plane orthogonal to an optical axis in accordance with a direction and magnitude of vibration applied to the imaging optical system; a memory in which area data is prestored, the area data designating changes in size of an image circle of the imaging optical system when the optical zoom device changes the focal length; and a moving range controller which changes a moving range of the shake correction optical element that corresponds to a change of the object coverage area in accordance with an operating state of the optical zoom device based on the area data prestored in the memory.

It is desirable for the moving range controller to change the moving range of the shake correction optical element within a range so that no part of an effective picture area of an imaging surface of the image sensor deviates outside from the image circle.

In an embodiment, an image stabilizer is provided, including an imaging optical system including an image sensor; an electronic zoom device which trims a part of an image formed on the image sensor to change an object coverage area for an object which is formed through the imaging optical system; an image shake correction device which moves a shake correction optical element of the imaging optical system in a plane orthogonal to an optical axis in accordance with a direction and magnitude of vibration applied to the imaging optical system; a memory in which area data is prestored, the area data indicating changes in size of an effective picture area of an imaging surface of the image sensor that corresponds to the object coverage area when the electronic zoom device changes the object coverage area; and a moving range controller which changes a moving range of the shake correction optical element that corresponds to a change of the effective picture area in accordance with an operating state of the electronic zoom device based on the area data prestored in the memory.

It is desirable for the moving range controller to change the moving range of the shake correction optical element within a range so that no part of the effective picture area deviates outside from the image circle.

In an embodiment, a method of correcting image shake in an imaging device is provided, wherein the imaging device includes an object coverage area changing device for changing an object coverage area for an object which is to be photographed through an imaging optical system, and an image shake correction device which moves a shake correction optical element of the imaging optical system in a plane orthogonal to an optical axis, the method including prestoring area data in a memory, the area data designating changes in 10 relative sizes between an image circle of the imaging optical system and an effective picture area of an imaging surface when the object coverage area changing device changes the object coverage area; reading the area data from the memory in accordance with an operating state of the object coverage area changing device to calculate a moving range of the shake correction optical element that corresponds to a change of the object coverage area based on the area data read out from the memory; and moving the shake correction optical element in the plane within the calculated moving range thereof in accordance with a direction and magnitude of vibration applied to the imaging optical system.

It is desirable for the moving range of the shake correction optical element, which is calculated based on the area data read out from the memory, to be determined within a range so that no part of the effective picture area deviates outside from the image circle.

According to the image stabilizer and the method of correcting image shake to which the present invention is applied, a compact image stabilizer can reliably correct image shake even if the magnification of the optical system thereof is large.

The present disclosure relates to subject matter contained in Japanese Patent Application No. 2005-303465 (filed on Oct. 18, 2005) which is expressly incorporated herein in its entirety.

### BRIEF DESCRIPTION OF THE DRAWINGS

The present invention will be discussed below in detail with reference to the accompanying drawings, in which:

FIG. 1 is a front elevational view of an embodiment of a digital camera equipped with an image stabilizer according to the present invention;

FIG. 2 is a schematic diagram of major elements of the digital camera shown in FIG. 1;

FIG. 3 is a conceptual illustration showing the relative positional relationship between the image sensor and the image circle of the imaging optical system of the digital camera before an electronic zoom operation is performed, and the moving range of the image sensor;

FIG. 4 is a view similar to that of FIG. 3, showing a shifted state of the moving range of the image sensor when an electronic zoom operation has been performed from the state shown in FIG. 3;

FIG. 5 is a conceptual illustration showing the relative positional relationship between the image sensor and the image circle of the imaging optical system of the digital camera at the wide-angle extremity, and the moving range of the image sensor;

FIG. 6 is a view similar to that of FIG. 5, showing the relative positional relationship between the image sensor and the image circle of the imaging optical system of the digital camera at the telephoto extremity, and the moving range of the image sensor;

FIG. 7 is a flow chart showing operations of an image-sensor moving range shifting control which are performed by the main CPU shown in FIG. 2; and

FIG. 8 is a flow chart showing operations of the image-sensor moving range shifting control which are performed by the shake correction control CPU shown in FIG. 2.

### DESCRIPTION OF THE PREFERRED EMBODIMENT

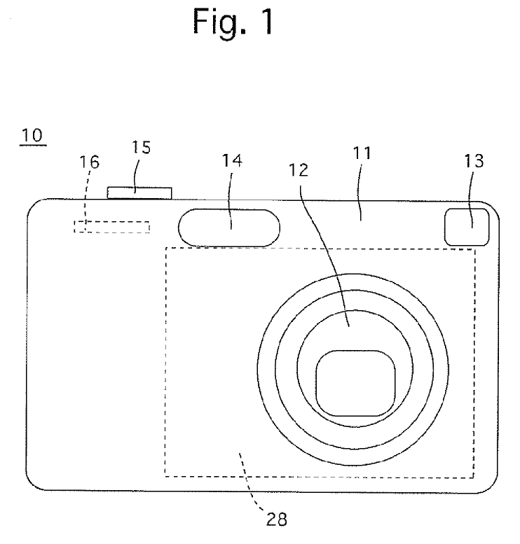

FIG. 1 shows a first embodiment of a digital camera (imaging device) 10 equipped with an optical axis correction apparatus according to the present invention. The digital camera 10 is provided on the front of a camera body 11 with a zoom lens (zoom lens barrel) 12, an optical viewfinder 13 and a flash 14. The digital camera 10 is provided on the top of the camera body 11 with a shutter release button 15. The digital camera 10 is provided on the back thereof with a zoom switch 16 and an LCD 28 which indicates the picture area (object coverage area).

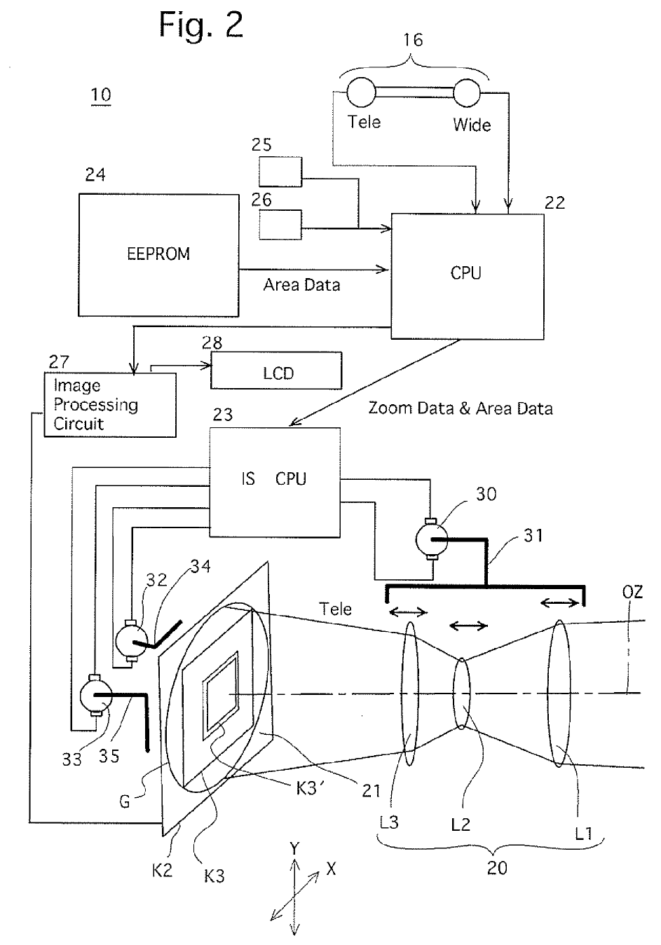

As shown in FIG. 2, the zoom lens 12 is provided with a zoom lens system (photographing optical system) 20 including a plurality of lens groups (first, second and third lens groups) L1, L2 and L3, and an image sensor (shake correction optical element) 21 which is located at a focal point of the zoom lens system 20. The optical axis of the zoom lens system 20 is shown by the letters “OZ” in FIG. 2. The digital camera 10 is provided therein with a main CPU (an element of a moving range controller/an element of an image shake correction controller) 22, a shake correction control CPU (an element of the moving range controller/an element of the image shake correction controller) 23, an EEPROM (memory) 24, an X gyro sensor 25 and a Y gyro sensor 26.

The first, second and third lens groups L1, L2 and L3, which are elements of the zoom lens system 20, are driven by a zoom mechanism (an element of an object coverage area changing device/an element of an optical zoom device) 31 including a zoom motor (an element of the object coverage area changing device/an element of the optical zoom device) 30 as a driving source of the zoom mechanism. The second lens group L2 is moved along the optical axis OZ by the zoom mechanism 31 to vary focal length of the zoom lens system 20. The zoom lens system 20, the image sensor 21 and the optical zoom device (30 and 31) constitute an imaging optical system. The zoom switch 16 is a momentary switch which can be selectively operated between the telephoto side (Tele) and wide-angle side (Wide). Operating the zoom switch 16 to telephoto side and wide-angle side causes the zoom lens system 20 to change to the long focal length side (telephoto extremity) and the short focal length side (wide-angle extremity), respectively.

In addition to the optical zoom function of the zoom lens system 20, the digital camera 10 includes an electronic zoom (digital zoom) function. As well known in the art, a digital zoom function is a digital image process in which a part (central part) of an electronic image (digital image) captured by an image sensor (e.g., CCD or CMOS sensor) is trimmed to change the object coverage area to thereby raise the scaling factor (display magnification) of an object image relative to the object viewed by the photographer. The digital camera 10 is provided with an image processing circuit (an element of the object coverage area changing device/an electronic zoom device) 27 which performs digital imaging processing (electronic zoom). When the zoom lens system 20 is at the telephoto extremity, further operating the zoom switch 16 to telephoto side causes the digital camera 10 to enter an electronic zoom mode in which an electronically image magnifying process is performed by the image processing circuit 27 under control of the main CPU 22.

The digital camera 10 is provided with an image stabilizer (anti-shake system/image shake correction device) including an X-direction drive mechanism (an element of the image shake correction device) 34 and a Y-direction moving device (an element of the image shake correction device) 35. The X-direction drive mechanism 34 and the Y-direction drive mechanism 35 are provided with an X-direction motor (an element of the image shake correction device) 32 and a Y-direction motor (an element of the image shake correction device) 33, respectively. The image sensor 21 can be moved by the X-direction drive mechanism 34 and the Y-direction drive mechanism 35 in a plane orthogonal to the optical axis OZ. Specifically, the X-direction drive mechanism 34 moves the image sensor 21 linearly in the horizontal direction (X-direction; see FIG. 2) in a plane orthogonal to the optical axis OZ, and the Y-direction drive mechanism 35 moves the image sensor 21 linearly in the vertical direction (Y-direction; see FIG. 2) in a common plane orthogonal to the optical axis OZ.

Note that if the K-direction drive mechanism 34 and the Y-direction drive mechanism 35 are driven at the same time independently, the image sensor 21 can be linearly moved or moved in a curved line as desired.

Deviations of an object image (image shake) on the imaging surface of the image sensor 21 can be corrected (offset) by moving the image sensor 21 in accordance with the direction and magnitude of vibration (shake) applied to the digital camera (the zoom lens system 20) by the X-direction drive mechanism 34 (which includes the X-direction motor 32) and the Y-direction drive mechanism 35 (which includes the Y-direction motor 33).

More specifically, the X gyro sensor 25 detects the angular velocity about the X-axis while the Y gyro sensor 26 detects the angular velocity about the Y-axis. The angular velocity detected by the X gyro sensor 25 and the angular velocity detected by the Y gyro sensor 26 are time-integrated to obtain an angle of movement, and subsequently, an X-direction deviation amount and a Y-direction deviation amount of an object image are calculated from an angle of movement thus obtained, and the amount of driving (moving) of the image sensor 21 and the direction of driving (moving) of the image sensor 21 (i.e., the amount of driving of the X-direction motor 32 and the amount of driving of the Y-direction motor 33) which are necessary for canceling the image shake of the object image are calculated. Subsequently, based on these calculated values, the shake correction control CPU 23 controls driving operations of the X-direction motor 32 and the Y-direction motor 33. This control suppresses (corrects) image shake of an object image picked up by the image sensor 21.

When an optical zoom operation or an electronic zoom operation is performed, the size relationship between the area of an image circle formed on the imaging surface of the image sensor 21 via the zoom lens system 20 and the effective picture area on the imaging surface of the image sensor 21 (the area trom which image data is actually captured) varies. The present invention directed toward this size change between the image circle and the effective picture area; i.e., the moving range of the image sensor 21 for image-shake correction is shifted appropriately within a range so that no part of the effective picture area deviates outside from the image circle when the object coverage area is changed by an optical zoom operation or an electronic zoom operation.

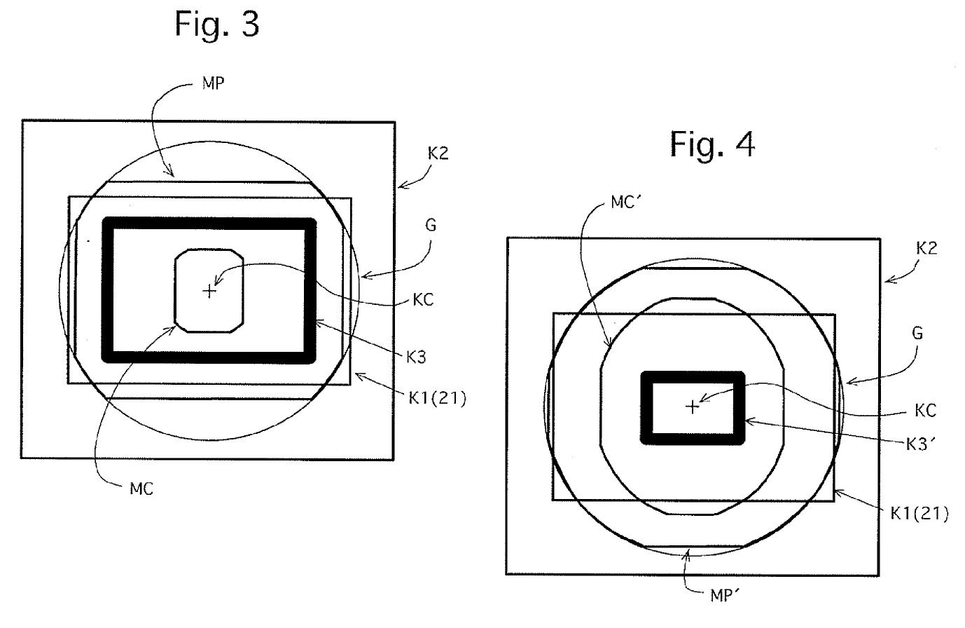

The concept of such a shifting operation of the moving range of the image sensor 21 for image-shake correction when an electronic zoom operation is performed will be hereinafter discussed with reference to FIGS. 3 and 4. FIG. 3 shows a state where the zoom lens system 20 is at the telephoto extremity without an electronic zoom operation being additionally performed. In FIG. 3, K1 represents the outside shape of the image sensor 21, K2 designates the mechanical moving range (mechanical moving limit) of the imaging surface of the Image sensor 21 (by the X-direction moving device 34 and the Y-direction moving device 35), K3 designates the effective picture area on the imaging surface of the image sensor 21, which is actually used for capturing image data, KC designates the center of the effective picture area, and G designates the image circle projected by the zoom lens system 20.

If the image sensor 21 is freely moved over the entire mechanical moving range K2 of the imaging surface of the image sensor 21 to correct image shake, there is a possibility of a part of the effective picture area K3 deviating outside from the image circle G, thus causing a part of the rectangular image to be cropped out in the final image. In addition, if the image sensor 21 is moved to a mechanical moving limit thereof, there is a possibility of a moving part hitting another part within the camera body 11, thus causing damage to occur. Therefore, the moving range of the image sensor 21 is electronically controlled so that the outer edge of the effective picture area K3 and the center KC of the effective picture area K3 remain within a range MP and a range MC shown in FIG. 3, respectively. The range MP and the range MC represent the electronic moving range of the outer edge of the effective picture area K3 and the electronic moving range of the center KC of the effective picture area K3, respectively, within the boundaries of a region where no part of the entire effective picture area K3 deviates outside from the image circle G (where no part of the entire rectangular image is cropped out in the final image). In other words, image quality is maintained by electronically limiting the moving range of the image sensor 21 in an image shake correction control.

FIG. 4 shows a state where the zoom lens system 20 is at the telephoto extremity with an electronic zoom operation being additionally performed. The size of the image circle G, the outside shape K1 of the imaging surface of the image sensor 21 and the mechanical moving range K2 of the imaging surface of the image sensor 21 in FIG. 4 are the same as those shown in FIG. 3. However, in preparation for an electronic zoom operation, the effective picture area K3 is reduced (trimmed) to an effective picture area (reduced effective picture area) K3′ which is smaller than the effective picture area K3. Thereupon, the moving range of the image sensor 21 is electronically controlled so that the outer edge of the effective picture area K3′ and the center KC of the effective picture area K3′ remain within a range MP′ and a range MC′ shown in FIG. 4 which are wider than the range MP and MC shown in FIG. 3, respectively. The range MP′ and the range MC′ represent the electronic moving range of the outer edge of the effective picture area K3′ and the electronic moving range of the center KC of the effective picture area K3′, respectively, within the boundaries of a region where no part of the entire effective picture area K3′ deviates outside from the image circle G (where no part of the entire rectangular image is cropped out in the final image).

Accordingly, when the digital camera 10 moves from the state shown in FIG. 3 in which the electronic zoom is not activated to the state shown in FIG. 4 in which the electronic zoom has been activated, the amount of driving of the image sensor 21 for image-shake correction can be increased by shifting the electronic moving range of the outer edge of the effective picture area K3 and the electronic moving range of the center KC of the effective picture area K3 from the narrow electronic moving range MP of the outer edge of the effective picture area K3 and the narrow electronic moving range MC of the center KC of the effective picture area K3 to the wide electronic moving range MP′ of the outer edge of the effective picture area K3′ and the wide electronic moving range MC′ of the center KC of the effective picture area K3′, respectively. In the case shown in FIG. 4, the outside shape K1 of the image sensor 21 reaches the mechanical moving range (mechanical moving limit) K2 of the imaging surface of the image sensor 21 before reaching the aforementioned boundaries of the region where no part of the entire effective picture area K3 deviates outside from the image circle s, and a further movement of the image sensor 21 is prevented. In any case, the mechanical moving range of the image sensor 21 can be effectively used, and the image stabilizer of the digital camera 10 can deal with image shake with no increase in size of the optical system or the image stabilizer of the digital camera 10 even if the amount of image-shake correction becomes great. Specifically when the object coverage area is reduced by an electronic zoom operation, enlarging the electronic moving range of the image sensor 21 is effective because the amount of image-shake correction per unit of shake angle increases as the scaling factor (display magnification) of an object image indicated on the LCD 20 (located on the back of the camera body 11) relative to the object increases.

Although the shifting operation of the moving range of the image sensor 21 for image-shake correction when an electronic zoom operation is performed has been discussed above only in two stages wherein the electronic zoom of the digital camera 10 is activated and not activated, respectively, it is possible that a desired object coverage area be selected from among different object coverage areas in an electronic zoom operation. Even in the case where the zoom range of the electronic zoom is provided as a stepwise zoom range, the effective picture area (K3′) used on the image sensor 21 becomes narrower as the display magnification increases, and therefore, according to this variation in the effective picture area, the moving range of the image sensor 21 only needs to be increased stepwise.

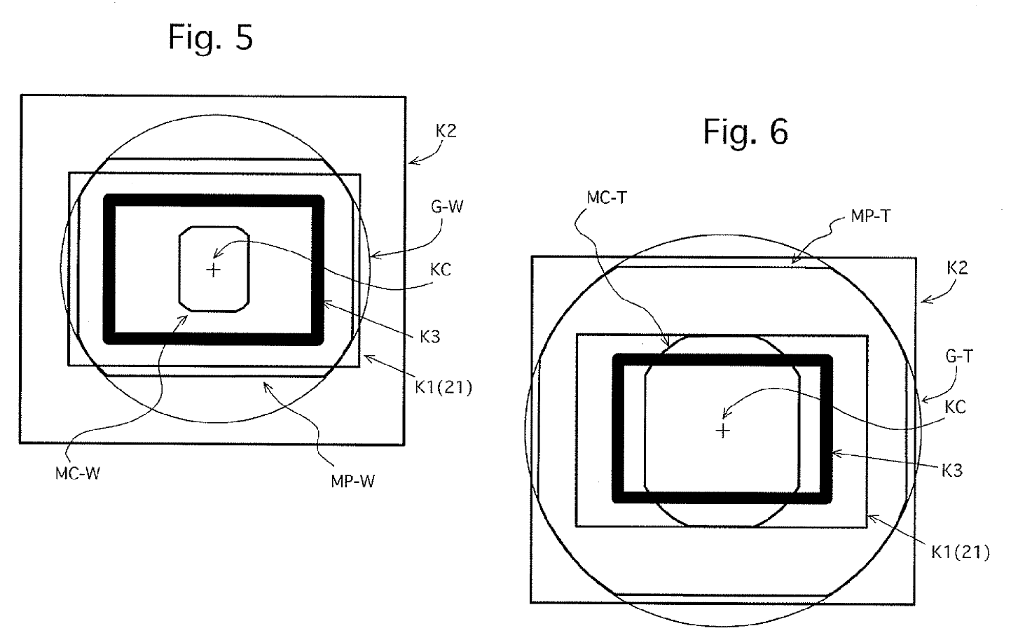

The concept of the shifting operation of the moving range of the image sensor 21 for image-shake correction when an optical zoom operation is performed will be hereinafter discussed with reference to FIGS. 5 and 6. In FIGS. 5 and 6, the outside shape K1 of the image sensor 21, the mechanical moving range K2 of the image sensor 21 and the effective picture area K3 on the imaging surface of the image sensor 21 are identical to those shown in FIG. 3. In regard to the image circle of the zoom lens system 20, although an image circle G-T shown in FIG. 6 when the zoom lens system 20 is at the telephoto extremity is greater than the image circle G shown in FIGS. 3 and 4 when the zoom lens system 20 is set at the telephoto extremity, this is only for the purpose of illustrating the difference in size between the image circle G-T and an image circle G-W shown in FIG. 5 when the zoom lens system 20 is at the wide-angle extremity, rather than for the purpose of obtaining the size of the image circle itself when the zoom lens system 20 is at the telephoto extremity.

FIG. 5 shows a state where the zoom lens system 20 is set at the wide-angle extremity. A range MP-W and a range MC-W shown in FIG. 5 represent the electronic moving range of the outer edge of the effective picture area K3 and the electronic moving range of the center KC of the effective picture area K3, respectively, within the boundaries of a region where no part of the entire effective picture area K3 deviates outside from the image circle G-W (no part of the entire rectangular image is cropped out in the final image).

FIG. 6 shows a state where the zoom lens system 20 is at the telephoto extremity. The image circle G-T shown in FIG. 6 when the zoom lens system 20 is at the telephoto extremity is larger than the image circle G-W when the zoom lens system 20 is at the wide-angle extremity. Therefore, an electronic moving range MP-T of the outer edge of the effective picture area K3 and an electronic moving range MC-T of the center KC of the effective picture area K3 within the boundaries of a region where no part of the entire effective picture area K3 deviates outside from the image circle G-T (no part of the entire rectangular image is cropped out in the final image) are wider than the aforementioned electronic moving range MP-W and the aforementioned electronic moving range MC-W, respectively.

Accordingly, when the zoom lens system 20 changes the angle of view from the wide-angle extremity (FIG. 5) to the telephoto extremity (FIG. 6), the amount of driving of the image sensor 21 for image-shake correction can be increased by shifting the aforementioned narrow electronic moving ranges MP-W and MC-W shown in FIG. 5 to the aforementioned wide electronic moving ranges MP-T and MC-T shown in FIG. 6, respectively. Consequently, the mechanical moving range of the image sensor 21 can be effectively used, and the image stabilizer of the digital camera 10 can deal with image shake with no increase in size of the optical system or the image stabilizer of the digital camera 10 even if the amount of image-shake correction becomes great. Specifically, when the scaling factor of an object image is increased (the object coverage area is reduced) by an optical zoom operation, enlarging the electronic moving range of the image sensor 21 is effective because the amount of image-shake correction per unit of shake angle increases.

Although the shifting operation of the moving range of the image sensor 21 for image-shake correction when an optical zoom operation is performed has been discussed above only in two stages wherein the digital camera 10 is set at the wide-angle extremity and the telephoto extremity, respectively, it is possible for a desired focal length to be selected from among different steps of focal lengths in an optical zoom operation. Even in the case where the zoom range of the optical zoom is a stepped zoom range, the electronic moving range of the image sensor 21 only needs to be widened stepwise according to the image circle obtained at each of the different steps of focal lengths.

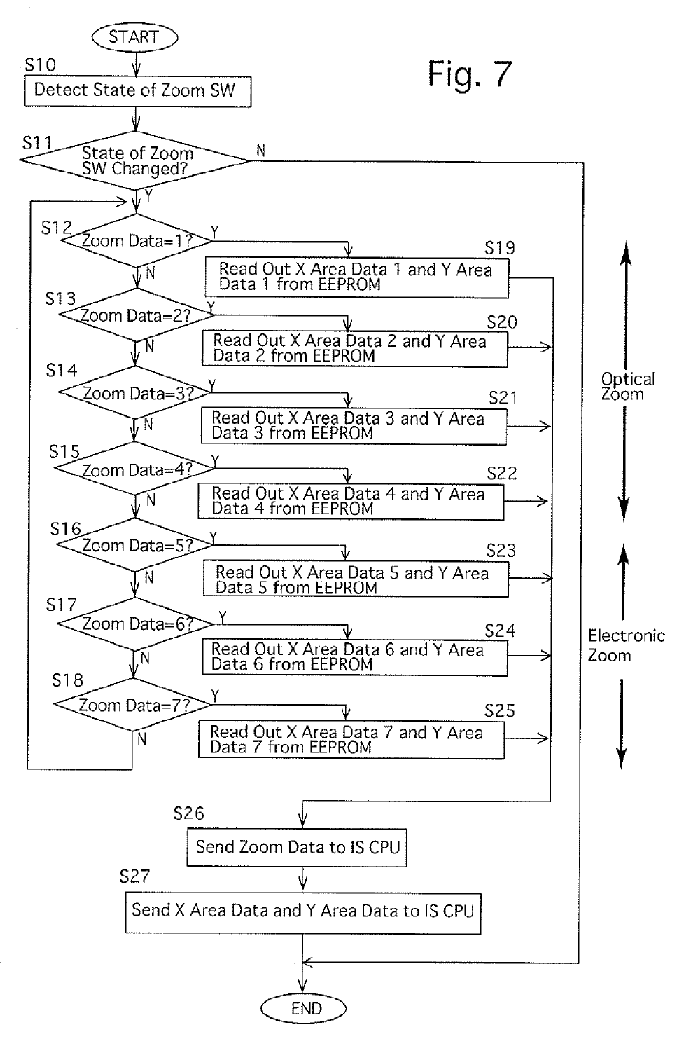

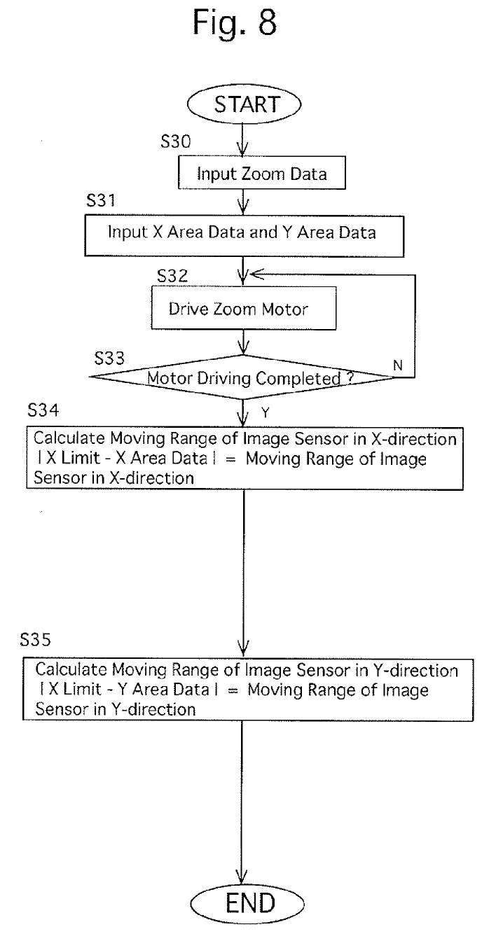

Control flow of the above described shifting operation of the moving range of the image sensor 21 for image-shake correction when an optical zoom operation or an electronic zoom operation is performed will be hereinafter discussed with reference to flow charts shown in FIGS. 7 and 8. As a precondition of this control, the zoom range of the optical zoom that is performed by operation of the optical zoom lens system 20 is configured to be a stepwise zoom range including four focal length steps in total from the wide-angle extremity to the telephoto extremity. In FIG. 7, four focal length data of these four focal length steps are shown as zoom data 1, 2, 3 and 4, respectively. Zoom data 1 and 4 correspond to the wide-angle extremity and the telephoto extremity, respectively, and zoom data 2 and 3 correspond to two intermediate focal lengths between the wide-angle extremity and the telephoto extremity, respectively. Additionally, in the electronic zoom operation, the scaling factor (display magnification/zoom) can be varied in three steps. In FIG. 7, the three scaling factor data are shown as zoom data 5, 6 and 7, respectively. Zoom data 5 designates the smallest scaling factor of the electronic zoom, zoom data 7 designates the greatest scaling factor of the electronic zoom, and zoom data 6 designates an intermediate scaling factor of the electronic zoom therebetween.

The range (size) of the image circle is measured beforehand at each of the four focal length steps in the zoom range of the optical zoom, and area data 1, 2, 3 and 4 which represent the four electronic moving ranges of the image sensor 21 that correspond to the four image circles at the four focal length steps, respectively, are written in the EEPROM 24. Additionally, the range (size) of the image circle is measured beforehand at each of the three steps of the stepwise electronic zoom range, and area data 5, 6 and 7 which represent the three electronic moving ranges of the image sensor 21 that correspond to the three effective picture areas at the three steps of the stepwise electronic zoom range, respectively, are written in the EEPROM 24. Each of area data 1 through 7 consists of X-direction area data and Y-direction area data which indicate an amount of driving of the X-direction motor 32 and an amount of driving of the Y-direction motor 33, respectively. Fourteen items of data in total: X-shift data 1 and Y-shift data 1 which correspond to zoom data 1 (the wide-angle extremity of the optical zoom) through X-shift data 7 and Y-shift data 7 which correspond to zoom data 7 (the maximum scaling factor of the electronic zoom) are stored in the EEPROM 24. Although the zoom range of the optical zoom is configured to have a stepwise optical zoom range of the four steps and the zoom range of the electronic zoom is configured to have a stepwise electronic zoom range of the three steps in the above illustrated embodiment, the number of the steps in each of the optical zoom and the electronic zoom is not limited solely to these particular number of steps.

The flow chart shown in FIG. 7 shows operations of an image-sensor moving range shifting control which are performed by the main CPU 22. Upon the zoom switch 16 being operated (step S10), it is determined whether the state of the zoom switch 16 has changed (step S11) If it is determined that the state of the zoom switch 16 has not changed (if NO at step S11), the relative positional relationship between the image circle and the effective picture area of the image sensor 21 has not varied, so that control ends without performing any operation for shifting the moving range of the image sensor 21 for image-shake correction. If it is determined that the state of the zoom switch 16 has changed (if YES at step S11), it is determined which of the seven steps from the wide-angle extremity of the optical zoom to the maximum scaling factor of the optical zoom has been selected by the operation of the zoom switch 16 (steps S12 through S11). Subsequently, X-direction area data and Y-direction area data of one of the seven zoom data 1 through 7 which corresponds to the selected zoom position are read out from the EEPROM 24 (steps S19 through S25), and zoom data n, X-direction area data n and Y-direction area data n are sent to the shake correction control CPU 23 (steps S26 and 27), wherein “n” corresponds to the selected zoom position number among the zoom positions 1 through 7. For instance, if the zoom switch 16 is operated to select the second zoom position (zoom data 6) of the electronic zoom (if YES at step S17), X-shift data 6 and Y-shift data 6 are read out from the EEPROM 24 (step S24).

Subsequently, control proceeds to the process shown in FIG. 8. The shake correction control CPU 23 inputs zoom data n, X-direction area data n and Y-direction area data n which are output from the main CPU 22 (steps S30 and S31). Subsequently, the shake correction control CPU 23 drives the zoom motor 30 according to the input zoom data n to change the focal length of the zoom lens system 20 (step S32). Thereupon, the second lens group L2 moves in the optical axis direction to vary the focal length of the zoom lens system 20. Immediately after it is determined that the focal length of the zoom lens system 20 has reached the set focal length, the zoom motor 30 is stopped.

If the input zoom data n is one of zoom data 5 through 7 of the electronic zoom, the zoom motor 30 is driven to the telephoto extremity. When the focal length of the zoom lens system 20 has reached the telephoto extremity, the zoom motor 30 is stopped.

If the zoom motor 30 driving operation is completed (if YES at step S33), the electronic moving range of the image sensor 21 in the X-direction is calculated (step S34). This electronic moving range is obtained by subtracting the input X-direction area data n from the mechanical moving range of the image sensor 21 in the X-direction (X limit). Subsequently, the electronic moving range of the image sensor 21 in the Y-direction is calculated (step S35). This electronic moving range is obtained by subtracting the input Y-direction area data n from the mechanical moving range of the image sensor 21 in the Y-direction (Y limit). Thereafter, the X-direction motor 32 and the Y-direction motor 33 are driven so that the image sensor 21 moves within the electronic moving ranges of the image sensor 21 in the X-direction and the Y-direction that are obtained at steps S34 and S35, respectively.

As can be understood from the foregoing, the mechanical moving range of the image sensor 21 can be used most effectively by determining an electronic moving range of the image sensor 21 by utilizing (adding) data of the mutual size relationship between the effective picture area and the image circle, the size relationship between which varies in accordance with the selected object coverage area. Therefore, even if the amount of movement of the image sensor 21 per unit of time for image-shake correction becomes great by increasing the scaling factor, the follow-up ability of the image stabilizer can be enhanced, which makes it possible to achieve a high image-correction capability within a compact structure.

Although the present invention has been discussed above with reference to the specific illustrated embodiment described above, the present invention is not limited solely thereto. For instance, although the above illustrated embodiment of the digital camera 10 is equipped with both an optical zoom function and an electronic zoom function, the present invention can also be applied to an imaging device equipped with only one of an optical zoom function and an electronic zoom function.

Obvious changes may be made in the specific embodiment of the present invention described herein, such modifications being within the spirit and scope of the invention claimed. It is indicated that all matter contained herein is illustrative and does not limit the scope of the present invention.

What is claimed is:

1. An image stabilizer comprising;
an imaging device including an object coverage area changing device for changing an object coverage area for an object which is to be photographed through an imaging optical system;
an image shake correction device which moves a shake correction optical element of said imaging optical system in a plane orthogonal to an optical axis in accordance with a direction and magnitude of vibration applied to said imaging device;
a memory, in which area data is prestored, said area data designating changes in relative sizes between an image circle of said imaging optical system and an effective picture area of an imaging surface of said imaging device when said object coverage area changing device changes said object coverage area; and
a moving range controller which changes a moving range of said shake correction optical element that corresponds to a change of said object coverage area in accordance with an operating state of said object coverage area changing device based on said area data prestored in said memory.

2. The image stabilizer according to claim 1, wherein said moving range controller changes said moving range of said shake correction optical element within a range so that no part of said effective picture area deviates outside from said image circle.

3. The image stabilizer according to claim 1, wherein said object coverage area changing device comprises an optical zoom device which changes distances in said optical axis direction between optical elements of said imaging optical system that are positioned on said optical axis to vary an optical focal length.

4. The image stabilizer according to claim 3, wherein said moving range controller operates so as to increase said moving range of said shake correction optical element as said optical focal length of said optical zoom device increases.

5. The image stabilizer according to claim 1i wherein said imaging optical system comprises an image sensor which produces an electronic image of said object, and
wherein said object coverage area changing device trims a part of said electronic image to change said effective picture area.

6. The image stabilizer according to claim 5, wherein said moving range controller operates so as to increase said moving range of said shake correction optical element as an area of a remaining part of said electronic image, that remains after said trimming, decreases.

7. The image stabilizer according to claim 1, wherein said imaging optical system comprises an image sensor which produces an electronic image of said object,
wherein said object coverage area changing device comprises:
an optical zoom device which changes distances in said optical axis direction between optical elements of said imaging optical system that are positioned on said optical axis to vary an optical focal length; and
an electronic zoom device which trims a part of an image formed on said image sensor to change said effective picture area.

8. The image stabilizer according to claim 1, wherein said shake correction optical element comprises an image sensor.

9. The image stabilizer according to claim 1, wherein said imaging optical system comprises a zoom lens system and an image sensor.

10. An image stabilizer comprising;
an imaging optical system including an image sensor and an optical zoom device for changing a focal length;
an image shake correction device which moves a shake correction optical element of said imaging optical system in a plane orthogonal to an optical axis in accordance with a direction and magnitude of vibration applied to said imaging optical system;
a memory in which area data is prestored, said area data designating changes in size of an image circle of said imaging optical system when said optical zoom device changes said focal length; and
a moving range controller which changes a moving range of said shake correction optical element that corresponds to a change of said object coverage area in accordance with an operating state of said optical zoom device based on said area data prestored in said memory.

11. The image stabilizer according to claim 10, wherein said moving range controller changes said moving range of said shake correction optical element within a range so that no part of an effective picture area of an imaging surface of said image sensor deviates outside from said image circle.

12. An image stabilizer comprising:
an imaging optical system including an image sensor;
an electronic zoom device which trims a part of an image formed on said image sensor to change an object coverage area for an object which is formed through said imaging optical system;
an image shake correction device which moves a shake correction optical element of said imaging optical system in a plane orthogonal to an optical axis in accordance with a direction and magnitude of vibration applied to said imaging optical system;
a memory in which area data is prestored, said area data indicating changes in size of an effective picture area of an imaging surface of said image sensor that corresponds to said object coverage area when said electronic zoom device changes said object coverage area; and
a moving range controller which changes a moving range of said shake correction optical element that corresponds to a change of said effective picture area in accordance with an operating state of said electronic zoom device based on said area data prestored in said memory.

13. The image stabilizer according to claim 12, wherein said moving range controller changes said moving range of said shake correction optical element within a range so that no part of said effective picture area deviates outside from said image circle.

14. A method of correcting image shake in an imaging device,
wherein said imaging device includes an object coverage area changing device for changing an object coverage area for an object which is to be photographed through an imaging optical system, and an image shake correction device which moves a shake correction optical element of said imaging optical system in a plane orthogonal to an optical axis, said method comprising:
prestoring area data in a memory, said area data designating changes in relative sizes between an image circle of said imaging optical system and an effective AD picture area of an imaging surface when said object coverage area changing device changes said object coverage area;
reading said area data from said memory in accordance with an operating state of said object coverage area changing device to calculate a moving range of said shake correction optical element that corresponds to a change of said object coverage area based on said area data read out from said memory; and
moving said shake correction optical element in said plane within said calculated moving range thereof in accordance with a direction and magnitude of vibration applied to said imaging optical system.

15. The image shake correction method according to claim 14, wherein said moving range of said shake correction optical element, which is calculated based on said area data read out from said memory, is determined within a range so that no part of said effective picture area deviates outside from said image circle.
